(19) United States
(12) Patent Application Publication
(10) Pub. No.: US 2011/0122161 A1
(43) Pub. Date: May 26, 2011

(54) DISPLAY CHARACTERIZATION WITH FILTRATION

(76) Inventor: Bongsun Lee, Cupertino, CA (US)

(21) Appl. No.: 12/737,571

(22) PCT Filed: Jul. 29, 2008
(86) PCT No.: PCT/US08/09147

§ 371 Date: Jan. 27, 2011

(51) Int. Cl. G09G 5/10

(52) U.S. Cl. 345/690

(57) ABSTRACT

A display and a method of characterizing a display includes a means of enabling the display to be measured by a characterization system having a measurement sensor that measures a difference between display characteristics and target values of a screen. The screen is provided with at least a first filter. The first filter is a color correction filter that decreases the difference between the display characteristics and the target values of the screen.

### FIELD OF THE INVENTION

This invention relates to a display and a method of characterizing a display wherein the display includes a characterization system adapted to work with a measurement sensor that measures a difference between display characteristics and target values of a screen, wherein the screen is provided with at least a first filter, which is a color correction filter that decreases the difference between the display characteristics and the target values of the screen.

### BACKGROUND OF THE INVENTION

Displays, such as flat-panel displays, need to be calibrated or characterized so that the colors in an image reproduced by the display are an accurate representation of the colors originally intended to be displayed in the image. The colors originally intended to be displayed in the image by a creator of the image is typically referred to as a target look, which can be compared to a reference look. The reference look can be a universal standard or can be referenced against a universal or recognized standard on a standard reference display, which can be a CRT, for example. The director or creator can use the standard display in post-production to determine and/or assist the director or creator in obtaining the look of the images that are or are consistent with the intent for the director or creator.

A goal of the display industry is to calibrate the target display to have the same performance as the standard reference display, so that the look of any video content can be matched to the standard reference display. In other words, each display needs to be calibrated or characterized so that the image that viewers see on the display looks the same or similar to the image originally intended and created for commercial and/or profession displays. Further, this means that the target displays must be capable of obtaining the reference look.

There are many known calibration systems for calibrating or characterizing a display so that the images generated by the display are similar or identical to the reference look. The calibration system generally measures the characteristics of the display and calibrates the display to produce target values such as primary color gamut, gamma, color temperature, etc. consistent with the reference look. One limitation of many of these calibration systems is that the performance of the calibration often depends on the original characteristics of the display. If the display shows too much deviation from target primary such as Rec. 709, which is a broadcasting standard, or color temperature (e.g., 6500K), then the calibration or characterization results are often not satisfactory. For example, if a correlated color temperature (CCT) of white on the display is 12,000K and the target value is daylight 6,500K, the deviation is so large that the characterization can not be properly performed. It is therefore necessary to provide an external device or method that compensates for the deviation between the display characteristics and the target value in order to ensure optimal characterization of the display and that the display is adapted to be calibrated.

### SUMMARY OF THE INVENTION

A display comprises a characterization system adapted to work with a measurement sensor that measures a difference between display characteristics and target values of a screen. The screen is provided with at least a first filter. The first filter is a color correction filter that decreases the difference between the display characteristics and the target values of the screen.

A method for characterizing the display comprises: measuring a difference between display characteristics and target values of a screen of a display; and providing the display with at least a first filter, the first filter being a color correction filter that decreases the difference between the display characteristics and the target values of the screen.

### BRIEF DESCRIPTION OF THE DRAWINGS

FIG. 1 is an exploded view of a display according to an embodiment of the invention.

FIG. 2 is a plan view of the display of FIG. 1 shown with a first filter and a second filter.

FIG. 3 is a graph showing the characteristics of the first filter of the display of FIG. 1.

FIG. 4 is a graph showing the characteristics of the second filter of the display of FIG. 1.

FIG. 5 is a schematic illustration of the display 1 of FIG. 1 shown with a characterization system.

### DETAILED DESCRIPTION

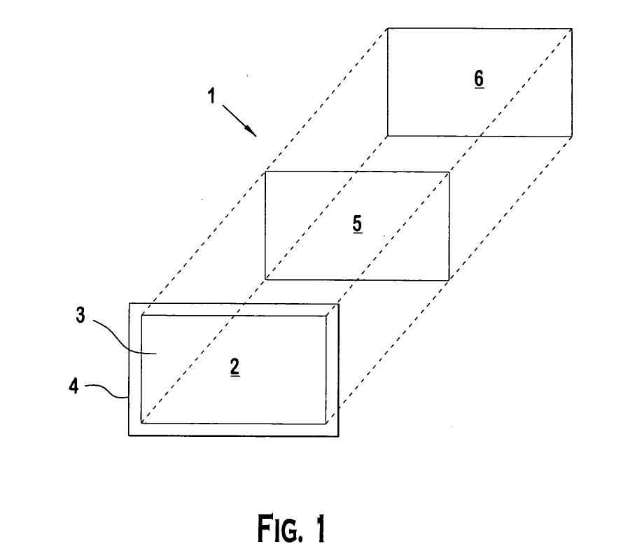

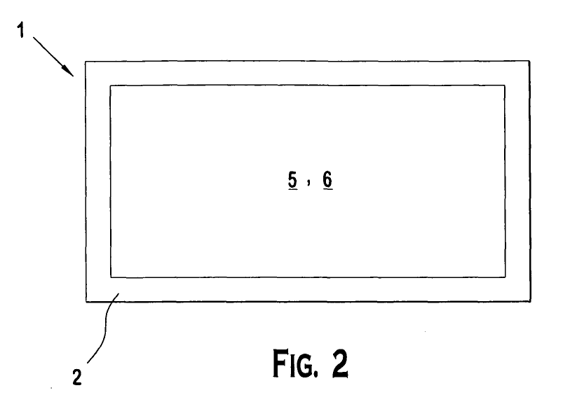

FIG. 1 shows a display 1 according to an embodiment of the invention. The display 1 can be, for example, a flat-panel display such as a liquid crystal display (LCD), plasma display, or liquid crystal on silicon (LCoS) display. As shown in FIGS. 1-2, the display 1 includes a screen 2 having a front surface 3 and an opposing rear surface 4. In the illustrated embodiment, the front surface 3 is configured to face a viewer (not shown) of the screen 2. The screen 2 can be made, for example, from glass.

The screen 2 is provided with a first filter 5 and a second filter 6. In the illustrated embodiment, the first filter 5 and the second filter 6 are attached to the front surface 3 of the screen 2. The first filter 5 is arranged on the front surface 3 of the screen 2, and the second filter 6 is arranged directly on top of the first filter 5. The first filter 5 and the second filter 6 cover an entirety of the front surface 3 of the screen 2. Alternatively, the first filter 5 and the second filter 6 can be provided on the rear surface 4. Additionally, the first filter 5 and the second filter 6 can be arranged inside the screen 2. For example, if the screen 2 is made of glass, the first filter 5 and the second filter 6 can be arranged inside the glass of the screen 2.

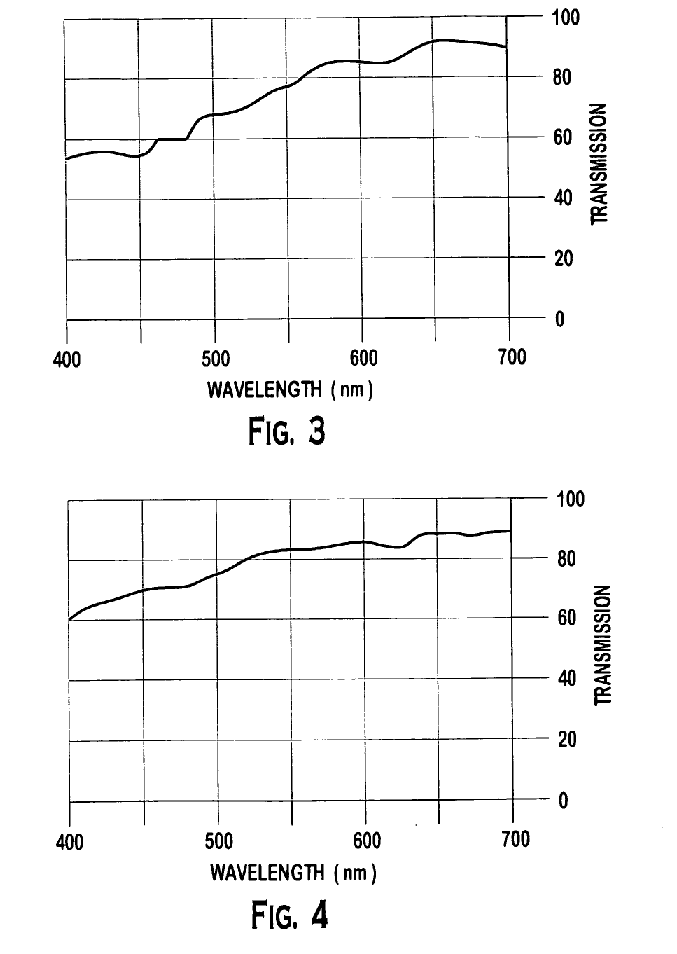

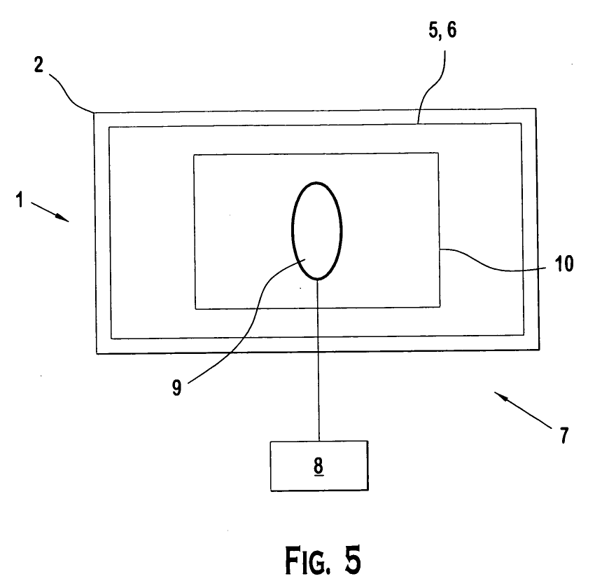

The first filter 5 and the second filter 6 can be, for example, gel filters or color correction filters for daylight, tungsten, fluorescent or arc correction or conversion. For example, the color correction filters can be color correction orange (CTO) that convert daylight to tungsten light and/or color correction blue (CTB) that convert tungsten light to daylight. In the illustrated embodiment, the first filter 5 and the second filter 6 are CTO and convert daylight to tungsten light. The first filter 5 is ¼ CTO, and the second filter 6 is ⅛ CTO. The combination of the first filter 5 and the second filter 6 is therefore ⅜ CTO. The characteristics of the first filter 5 are illustrated in more detail in FIG. 3, and the characteristics of the second filter 6 are illustrated in more detail in FIG. 4.

Although the screen 2 is illustrated and described as having the first filter 5 and the second filter 6 with the characteristics described above, it will be appreciated by those skilled in the art that the number, type, and strength of the filters provided on the screen 2 can be varied depending on the desired characteristics of the display 1. For example, the number, type, and strength of the filters can be determined by initially measuring the transmission of the display 1 that is to be characterized by any known method. If the display 1 shows more transmission in a blue spectral region (e.g., if a measured value of the white on the display 1 is about 12,000K and a target value for the white is about 6,500K), at least one CTO type filter can be used to filter out excessive blue transmission. If the display 1 shows more transmission in a yellowish-red spectral region (e.g., if the measured value of the white on the display 1 is about 3,000K and the target value for the white is about 6,500K), at least one CBT type filter can be used to filter out excessive yellowish-red transmission. Depending on the difference between the measured value and the target value, the most appropriate number and strength of the filters can be chosen.

As shown in FIG. 5, the display 1 is connected to a characterization system 7. In the illustrated embodiment, the characterization system 7 includes a personal computer (PC) 8 and a measurement sensor 9. The measurement sensor 9 is connected to the PC 8 via a standard communication channel, for example, a universal serial bus (USB) or RS-232C. Software running on the PC 8 generates at least one zone 10 on the screen 2 and drives the measurement sensor 9 to measure the zone 10 on the screen 2. Values achieved from the measurement sensor 9 are used to derive a characterization model which maps device dependent values (e.g., RGB) to device independent values (e.g., CIEXYZ). The characterization model is then used to generate a mapping, such as a three dimensional look-up-table, which produces a reference look on the screen 2. Because the characterization system 7 is known in the art, further description thereof has been omitted. Although the display 1 is illustrated and described as having the characterization system 7 illustrated and described herein, it will be appreciated by those skilled in the art that any known characterization systems can be used with the display 1.

Table 1 shows the characterization results on the screen 2 when the first filter 5 and the second filter 6 are not attached to the screen 2, and the characterization results on the screen 2 when the first filter 5 and the second filter 6 are attached to the screen 2. Delta E is the color difference errors between the original characteristics of the display 1 and the target values. In Table 1, 125 patches or unique color combinations (5 levels for R×5 levels for G×5 levels for B in an 8 bit system) of the zones 10 were used to calculate the color difference errors. A display according to the invention can have memory that stores the 125 patches such that the proper operating conditions will be known for the display to be calibrated with respect to a broadcasting standard or reference look and will, in return, be able to operate and display some movie as intended in post-production. The display having the patches in memory enables the display to be readily calibrated immediately after display assembly or in the field, if necessary. Alternatively, memory can be in some external device such as set-top box, video player, computer, or other standalone devices.

TABLE 1
Characterization Results

| Display Configuration | Average ΔE | Maximum ΔE |
|---|---|---|
| Without the first filter or the second filter | 7.6 | 14.5 |
| With the first filter and the second filter | 3.4 | 7.8 |

As shown in Table 1, use of the first filter 5 and the second filter 6 on the screen 2 improve the characterization accuracy more than a factor of 2. The first filter 5 and the second filter 6 improved the characterization accuracy, because the first filter 5 and the second filter 6 changed the color temperatures and the chromaticity of the screen 2 to move the value of the color temperatures and the chromaticity closer to the target values.

Table 2 shows a comparison of the luminance Y, chromaticity x, chromaticity y, and white point CCT when the first filter 5 and the second filter 6 are not attached to the screen 2, and when the first filter 5 and the second filter 6 are attached to the screen 2.

TABLE 2
Changes of Display Color Properties

| Display | | Lumi- | Chroma- | Chroma- | White |
|---|---|---|---|---|---|
| Config- | Display | nance | ticity | ticity | Point |
| uration | Color | Y | x | y | CCT |
| Without the | White | 178.8 | 0.2651 | 0.2865 | 12090K |
| first filter or | | | | | |
| the second | | | | | |
| filter | | | | | |
| Without the | Black | 0.1760 | 0.2725 | 0.2326 | 26050K |
| first filter or | | | | | |
| the second | | | | | |
| filter | | | | | |
| With the first | White | 121.6 | 0.3071 | 0.3359 | 6741K |
| filter and the | | | | | |
| second filter | | | | | |
| With the first | Black | 0.1271 | 0.3202 | 0.2786 | 6454K |
| filter and the | | | | | |
| second filter | | | | | |

As shown in Table 2, when the first filter 5 and the second filter 6 were used to compensate for a large degree of deviation in the display characteristics from the target values, the characterization performance was greatly improved. Because the first filter 5 and the second filter 6 are provided on the screen 2, the display 1 changes the primary and color temperature of the screen 2 closer to the target values; therefore, the characterization system 7 can achieve better quality of characterization or calibration of the display 1.

In the display 1 according to the invention, the first filter 5 and the second filter 6 provide an external device or method that compensates for the deviation between the display characteristics and the target value in order to ensure optimal characterization of the display 1. Thus, by integrating the first filter 5 and the second filter 6 with the screen 2 during the manufacturing process, better characterization or calibration will be ensured and the viewer (not shown) will get the benefit of an improved image on the display 1 and experience image characteristics as intended by the director or creator.

In sum, the invention includes the display having a means of enabling the display to be calibrated, recalibrated or measured by a characterization system having a measurement sensor that measures a difference between display characteristics and target values of a screen, wherein at least one target value can be an industry standard value. The screen is provided with at least a first filter, wherein the first filter can be a color correction filter that decreases the difference between the display characteristics and the target values of the screen. The first filter can set the display to operate such that it can match or achieve a reference look, and as such, the display can match or achieve the target look as intended by a director or creator. The first filter can be a color correction orange that converts daylight to tungsten light or color correction blue that converts tungsten light to daylight and the first filter can be complemented with a second filter, which can, for example, be a color correction orange that converts daylight to tungsten light or color correction blue that converts tungsten light to daylight. The enabling means can include the series of patches stored in memory of the display and can also having a measurement sensor input such as a USB port or the like for correlating measured display outputs to at least one the patches. In memory, the display can have a look-up table that contains the series of patches and the look-up table can be adapted to dynamically associate a given patch to the target values.

Other features of the invention include the first filter and/or the second filter, if present, being detachable such that the display can be recalibrated in case of an improper earlier calibration or a drift in the display over time. The screen can also be divided into different sections so that different patches of the plurality of patches can be assigned to the different sections of the screen in case the screen in not uniform. In fact, in case of non-uniformity, the first filter and/or second filter, if there is one, can be divided to have different color characteristics associated with different sections of the screen.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

1. A display, comprising:
a characterization system adapted to work with a measurement sensor that measures a difference between display characteristics and target values of a screen; and
the screen provided with at least a first filter, the first filter being a color correction filter that decreases the difference between the display characteristics and the target values of the screen.

2. The display of claim 1, wherein the first filter is color correction orange that converts daylight to tungsten light or color correction blue that converts tungsten light to daylight.

3. The display of claim 1, wherein the screen has a front surface that faces a viewer and an opposing rear surface, the first filter being provided on the front surface.

4. The display of claim 1, further comprising a second filter, the second filter being a color correction filter.

5. The display of claim 4, wherein the second filter is color correction orange that converts daylight to tungsten light or color correction blue that converts tungsten light to daylight.

6. A method comprising:
measuring a difference between display characteristics and target values of a screen of a display; and
providing the display with at least a first filter, the first filter being a color correction filter that decreases the difference between the display characteristics and the target values of the screen.

7. The method of claim 6, further comprising the step of providing the step of color correcting orange by converting daylight to tungsten light or color correcting blue by converting tungsten light to daylight with the first filter.

8. The method of claim 6, further comprising the step of providing a second filter, the second filter being a color correction filter.

9. The method of claim 6, further comprising the step of color correcting orange by converting daylight to tungsten light or color correcting blue converting tungsten light to daylight with a second filter.

10. A display, comprising:
a means of enabling the display to be measured by a characterization system having a measurement sensor that measures a difference between display characteristics and target values of a screen; and
the screen provided with at least a first filter, the first filter being a color correction filter that decreases the difference between the display characteristics and the target values of the screen.

11. The display of claim 10, wherein the enabling means comprises a series of patches in memory and a measurement sensor input for correlating measured display outputs to at least one the patches.

12. The display of claim 11, wherein the display has a look-up table that contains the series of patches and the look-up table is adapted to dynamically associate a given patch to the target values.

13. The display of claim 12, wherein at least one target value is an industry standard value.

14. The display of claim 10, wherein the first filter is color correction orange that converts daylight to tungsten light or color correction blue that converts tungsten light to daylight.

15. The display of claim 14, further comprising a second filter, the second filter being a color correction filter.

16. The display of claim 15, wherein the second filter is color correction orange that converts daylight to tungsten light or color correction blue that converts tungsten light to daylight.

17. The display of claim 10, wherein the first filter is detachable.

18. The display of claim 10, wherein the screen is divided into different sections and different patches of the plurality of patches are assigned to the different sections.

19. The display of claim 18, wherein the screen is divided into sections and the first filter is divided to have different color characteristics associated with different sections.

20. The display of claim 18, wherein the first filter is detachable.
